(19) United States
(12) Patent Application Publication
(10) Pub. No.: US 2006/0218859 A1
(43) Pub. Date: Oct. 5, 2006

(54) Synthetic plant and floral supports shaped like natural twigs

(76) Inventor: Beth Louise MacFarlane, Cambria, CA (US)

Correspondence Address: BETH L. MACFARLANE, 558 HUNTINGTON RD, CAMBRIA, CA, 93428, US

(21) Appl. No.: 11/372,412

(22) Filed: Mar. 10, 2006

Related U.S. Application Data
(60) Provisional application No. 60/594,213, filed on Mar. 18, 2005.

(51) Int. Cl. A01G 9/12; A01G 17/10

(52) U.S. Cl. 47/47

(57) ABSTRACT

The objective is to produce height adjustable plant & floral supports that require no fasteners, do not harm the plant, appear to be a natural part of the plant, enhance the look of the plant and/or floral arrangement and are made of a plastic material which is resistant to weather, moisture, infestation and disease.

### BACKGROUND OF THE INVENTION—FIELD OF INVENTION

This invention relates to plastic supports specifically designed to support plant stems & floral bouquets.

### BACKGROUND OF THE INVENTION

Plants commonly need some type of support in order to prevent injury to the plant often caused by weather &/or unruly growth. Plants & floral bouquets often need support to maintain integrity of design.

There are many products available to the gardener & to the florist to deal with these issues:

Stakes which support when plant stem is tied to stake, often causing plant damage & an unnatural looking result, especially if several stems are tied to the support stake

Decorative stakes often of metal, brightly colored & unnatural in appearance & with support capabilities which vary in degree of success.

Wire cage-like frames which are placed around the plant - again, unnatural in appearance.

### DESCRIPTION

This invention relates to a Plastic Twig device that is constructed in one piece—a stem with arms. The stem of the synthetic twig goes into the plant soil next to the plant needing support. The plant leans into the Y of the twig which holds the plant up without ties & possible injury to the plant.

The Plastic Twigs allow plant stems to lean into the Y of the support in such a way that the use of ties will be unnecessary. The usual way of supporting plant stems is with a straight stake & a tie. The ties can, & often do, injure the plant—especially those with delicate stems. The Plastic Twigs are designed to look natural i.e. to look like part of the plant, so as to make it difficult to detect.

The size of this device may vary—short, thin, tall or thicker. The number of twig arms may also vary. The colors & shapes will be natural with the goal being to blend in with the hues & shapes in nature.

### DRAWING DESCRIPTION

FIG. 1: Multiple arms notched for easy height adjustment

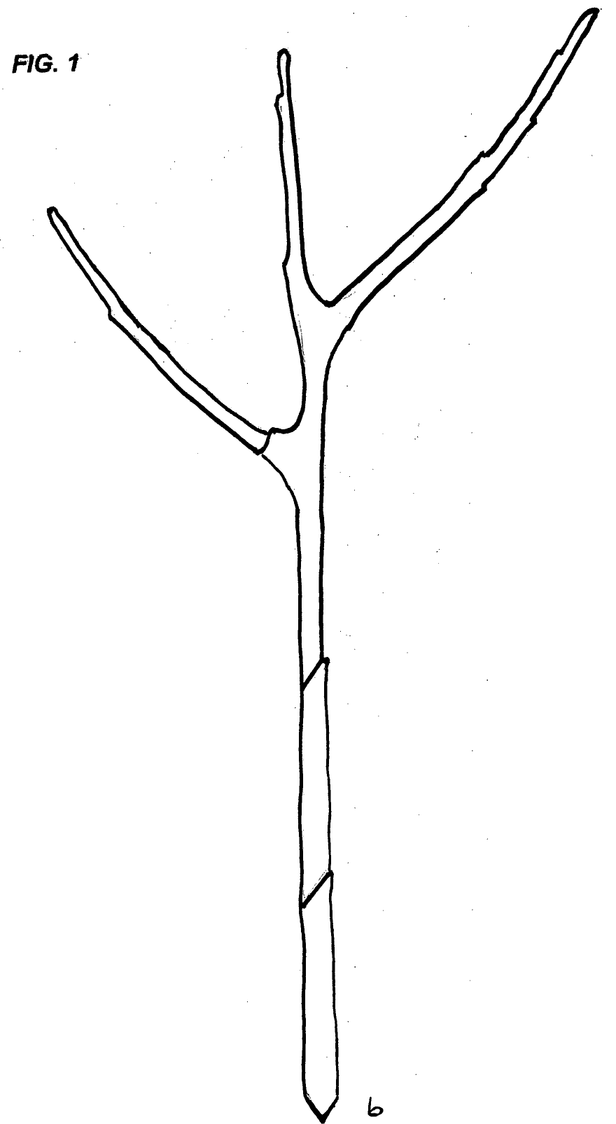

FIG. 2: Close up of notch

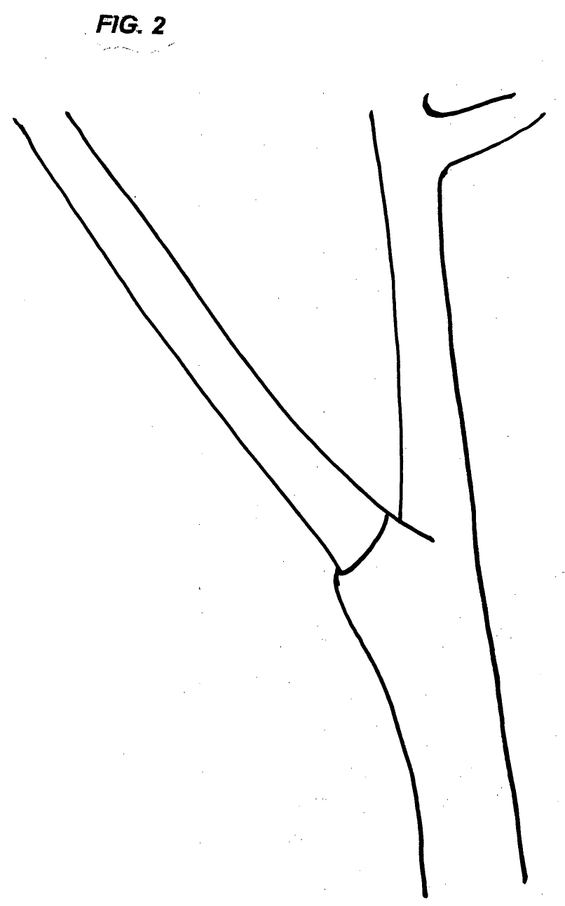

What is claimed is:

1. This is a natural looking plastic twig-shaped device for plants & floral arrangements. When the “stem” of this support is placed into the soil next to the supported plants, the plant can lean into the “Y” portion of the support without the need for ties or fasteners. The natural colors & shapes of the supports will mask their presence.
